(19) United States
(12) Patent Application Publication
(10) Pub. No.: US 2004/0044660 A1
(43) Pub. Date: Mar. 4, 2004

(54) System and method for searching for image data using keywords

(76) Inventor: Moo-Sung Pyun, Anyang-shi (KR)

Correspondence Address: Joseph J. Buczynski, Roylance, Abrams, Berdo & Goodman, L.L.P., 1300 19th Street, N.W., Suite 600, Washington, DC, 20036, US

(21) Appl. No.: 10/454,594

(22) Filed: Jun. 5, 2003

(30) Foreign Application Priority Data
Sep. 2, 2002 (KR) 2002-52514

(51) Int. Cl. G06F 7/00

(52) U.S. Cl. 707/3

(57) ABSTRACT

A system and method for searching for image data using a keyword. The system and method perform the operations of: inputting a search word, determining whether the search condition of the inputted search word is a basic search, converting the inputted search word into a code, searching for a sequence header (SH) of compressed image data, and comparing the search word, which has been converted into code, with an information code stored at the sequence header (SH) in order to determine whether the inputted search word is present. The system and method further perform the operations of storing a picture number of the sequence header (SH) if the search word is present, searching for image data corresponding to the stored picture number, determining whether found image data is a still picture or a moving picture, and if the image data is a still picture, displaying the still picture, or if the image data is a moving picture, reproducing the moving picture.

### PRIORITY

This application claims priority to an application entitled “Method of Searching for Image Data Using Keywords” filed with the Korean Intellectual Property Office on Sep. 2, 2002 and assigned Serial No. 2002-52514, the contents of which are hereby incorporated by reference.

### BACKGROUND OF THE INVENTION

1. Field of the Invention

The present invention relates to a system and method for searching for image data, and more particularly, to a system and method for searching for image data using keywords.

2. Description of the Related Art

Current wireless networks have recently started to implement a video on demand (VOD) service. To view a particular picture on current VOD systems, the user should search the entire image data by pressing a “fast forward” button or a “rewind” button. However, such a search process is time-consuming for the user. Also, since moving picture files are becoming larger in volume, it will become more difficult to search for particular image data (for example, a picture, an article or a person) in a larger-volume moving picture file.

### SUMMARY OF THE INVENTION

Accordingly, the present invention is capable of substantially solving the above-mentioned problems occurring in image data searches performed by conventional techniques. In particular, an object of the present invention is to provide a system and method for searching for image data using keywords.

In order to substantially accomplish this and other objects, the present invention provides a system and method for compressing image data having been made searchable by a keyword. The system and method perform the operations of compressing image data, converting information represented by the image data into a code, and storing the code at a sequence header (SH) of the compressed image data.

Also, to substantially accomplish the aforementioned object, the present invention provides a system and method for searching for image data using a keyword, which perform the operations of inputting a search word, determining whether the search condition of the input search word is a basic search, converting the input search word into a code, searching for a sequence header (SH) of compressed image data, and comparing the search word, which has been converted into code, with an information code stored at the sequence header (SH) to determine whether said inputted search word is present. The system and method further perform the operations of storing a picture number of the sequence header (SH) if the search word is present, searching for image data corresponding to the stored picture number, determining whether found image data is a still picture or a moving picture, and, if said image data is a still picture, displaying the still picture, or if said image data is a moving picture, reproducing the moving picture.

Also, the present invention provides a system and method for searching for image data using a keyword, which perform the operations of inputting search words, determining whether the search condition of the input search words is a boolean search, converting the input search words into a code, and searching for a sequence header (SH) of compressed image data. The system and method also perform the operations of determining whether the search words converted into a code are all present in an information code stored at the sequence header (SH) if the search condition of the inputted search words is an “AND” logic search condition, or whether at least one of the search words converted into a code is present in an information code stored at the sequence header (SH) if the search condition of the inputted search words is an “OR” logic search condition, and storing a picture number of said sequence header (SH) if the search word or words are present. The system and method further perform the operations of searching for image data corresponding to the stored picture number, determining whether found image data is a still picture or a moving picture, and if the image data is a still picture, displaying the still picture, or if the image data is a moving picture, reproducing the moving picture.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating an example of the construction of a mobile phone according to an embodiment of the present invention;

FIG. 2 shows an example of a process of compressing image data according to an embodiment of the present invention;

FIG. 3 shows an example of the construction of a moving picture having a sequence header (SH) according to an embodiment of the present invention;

FIG. 4 shows an example of the construction of the sequence header (SH) of FIG. 3;

FIG. 5 is a flow chart showing an example of a process of compressing image data which is searchable by a keyword, according to an embodiment of the present invention;

FIG. 6 is a flow chart showing an example of a process of searching for image data when a keyword is input under a basic search condition according to an embodiment of the present invention; and

FIG. 7 is a flow chart showing an example of a process of searching for image data when keywords are input under a boolean search condition according to an embodiment of the present invention.

### DETAILED DESCRIPTION OF THE PREFERRED EMBODIMENTS

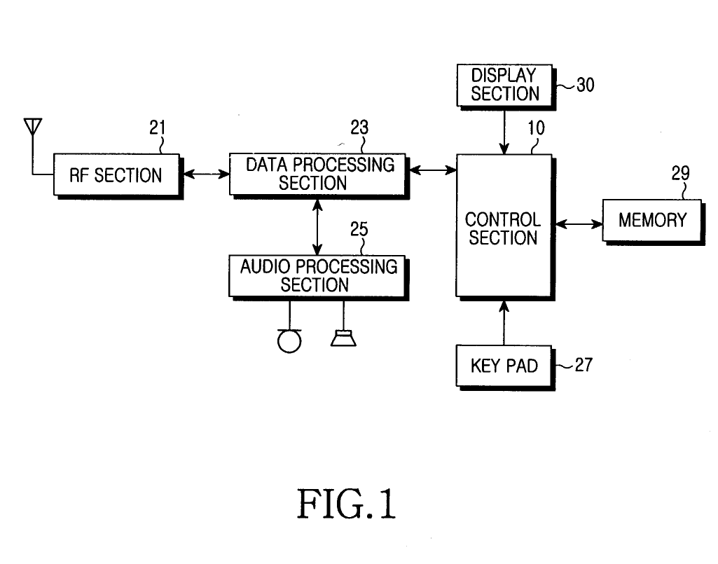

Example of several embodiments of the present invention will now be described in detail with reference to FIGS. 1 to 7.

FIG. 1 illustrates an example of the construction of a mobile phone according to an embodiment of the present invention. Referring to FIG. 1, a radio frequency (RF) section 21 enables communications through a mobile phone. The RF section 21 comprises an RF transmitter for performing upward conversion and amplification of the frequency of a transmitting signal, and an RF receiver for amplifying a receiving signal with low noise and performing downward conversion of the frequency of the receiving signal. A data processing section 23 comprises a transmitter for coding and modulating the transmitting signal, and a receiver for demodulating and decoding the receiving signal. That is, the data processing section 23 may be composed of a MODEM and a CODDEC.

An audio processing section 25 reproduces a receiving audio signal outputted from the data processing section 23, or transmits a transmitting audio signal generated from a microphone to the data processing section 23. A key pad 27 comprises function keys for setting up keys and various functions to input numbers and characters. A memory 29 may comprise a program memory and a data memory. The program memory stores programs for controlling general operations of the mobile phone, while the data memory temporarily stores data generated during implementation of the programs.

A control section 10 controls general operations of the mobile phone, and may include the data processing section 23. When image data that the user wishes to search for using a keyword is provided by a server, the control section 10 outputs the image data via a display section 30. The display section 30 displays the messages generated during implementation of a program under the control of the control section 10, and the user's key operation status when a call function is performed.

An example of the operation of the mobile phone will now be explained with reference to FIG. 1. If the user sets up a transmission mode for communication after dialing on the key pad 27, the control section 10 senses the mode, processes the dial information received from the data processing section 23, converts the information into an RF signal through the RF section 21, and output the signal. If the counterpart subscriber generates a response signal, the RF section 21 senses the signal through the data processing section 23. Then, a voice calling path is formed through the audio processing section 25 to enable communication. In incoming mode, the control section 10 senses that mode through the data processing section 23, and generates a ring signal through the audio processing section 25. If the user responds, the control section 10 senses the response, and forms a voice calling path through the audio processing section 25 to enable communication. Although voice communication is explained as an example of communications in transmission or incoming mode, data communications for packet or image data can also be performed in such a mode. In addition, in a hold mode or character communications mode, the control section 10 displays the character data processed by the data processing section 23 on the display section 30.

An example of the operation of searching for image data in a mobile phone using a keyword will now be explained. First, the server providing image data to the user of the mobile phone compresses the image data, which can be, for example, still pictures or moving pictures. A sequence header (SH) of the compressed image data stores a code representing the information of the image data, a code informing the number of a picture, a code informing the beginning and end of the header, and a code informing the beginning and end of the information. When the user of the mobile phone inputs a search word, the control section of the server converts the search word into a code. Thereafter, the control section searches the sequence header (SH), and compares the search word, which has been converted into code, with an information code stored at the sequence header (SH). If the search word is present in the information stored at the sequence header (SH), the picture number of the sequence header (SH) is stored. The control section then searches image data corresponding to the stored picture number. If the image data is a still picture, the control section displays the still picture. Alternatively, if the image data is a moving picture, the control section reproduces the moving picture.

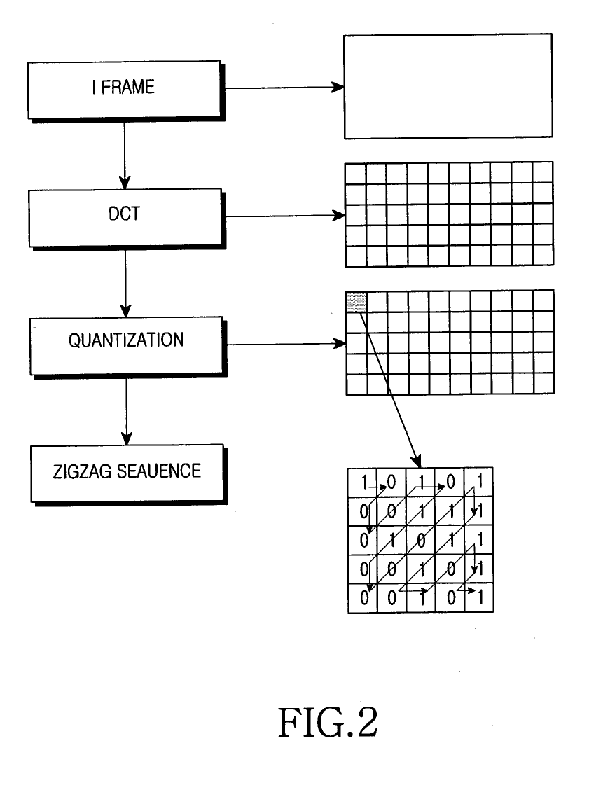

FIG. 2 shows an example of a process of compressing image data according to an embodiment of the present invention. Specifically, FIG. 2 shows both a compression process of a still picture by JPEG and a compression process of a still picture I-frame (intra-coded frame) in a moving picture.

Referring to FIG. 2, the DCT (discrete cosine transform) is concentrated on the low-frequency components in an image, while throwing out high-frequency components to remove spatial redundancy. In a quantization process, the low-frequency components are less quantized, while the high-frequency components are more quantized, in order to prevent damage to the original image and thereby improve the compression efficiency. A zigzag sequence process is performed to lay out the code of each picture.

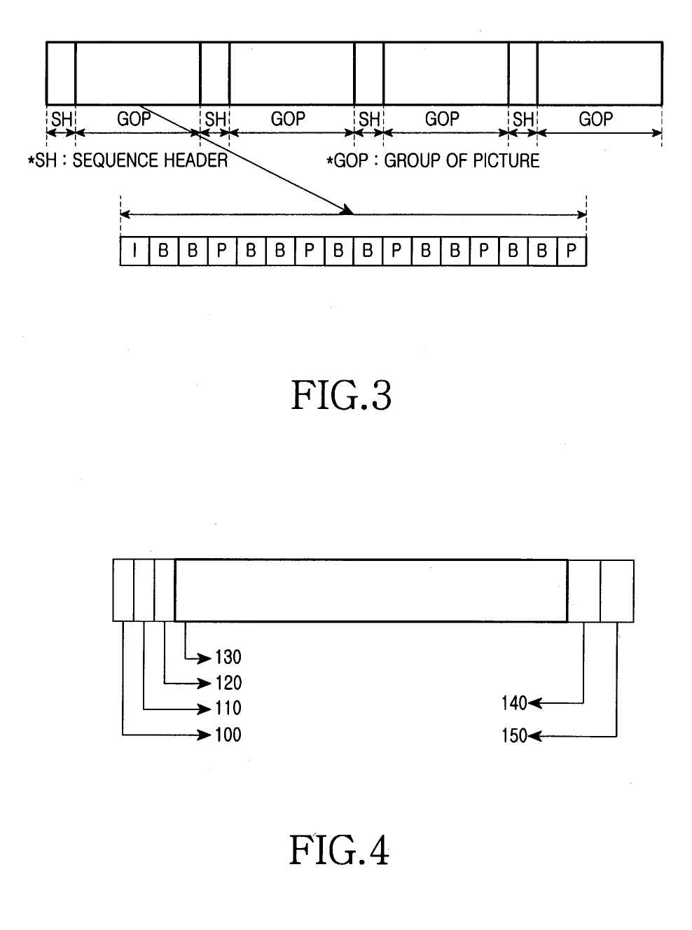

FIG. 3 shows an the construction of a moving picture having a sequence header (SH) according to an embodiment of the present invention. FIG. 4 shows an example of the construction of the sequence header (SH) of FIG. 3.

Referring to FIG. 4, the sequence header (SH) according to an embodiment of the present invention comprises a field 100 for storing a picture number of compressed image data, a field 110 for storing a code informing the beginning of the header, a field 120 for storing a code informing the beginning of information, a field 130 for storing a code representing the picture information of the compressed image data, a field 140 for storing a code indicating the end of the information, and a field 150 for storing a code informing the end of the header.

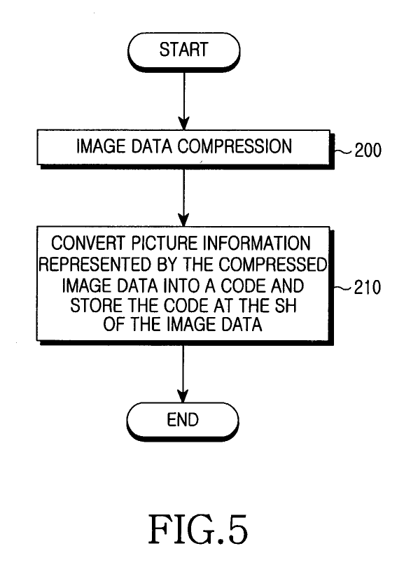

FIG. 5 is a flow chart showing an example of a process of compressing image data having been made searchable by a keyword, according to an embodiment of the present invention.

Hereinafter, the embodiments of the present invention discussed above will be described in more detail with reference to FIGS. 1 to 4.

During step 200, the server providing image data to the user of a mobile phone compresses the image data, namely, still pictures or moving pictures. As shown in FIG. 2, still pictures are compressed by DCT (discrete cosine transform), quantization and zigzag processes. Each compressed still picture has a sequence header (SH). Moving pictures are composed of a group of continuous pictures GOP (group of pictures) starting with an I-frame. The moving pictures composed of a GOP (group of pictures) have, as shown in FIG. 2, an I-frame (intra-coded frame) compressed to a still picture, a P-frame (predictive-coded frame) using prediction from a past frame, and an interpolating B-frame (bidirectional-coded frame) which are mixed in a particular pattern. FIG. 3 shows an example of the construction of the compressed moving pictures as explained above. Each compressed moving picture has a sequence header (SH). After compression of image data in step 200, the control section of the server converts into a code the information of a picture of a person or an object, which is shown from the image data, in step 210. The code-converted information is stored in the field 130 of the sequence header (SH).

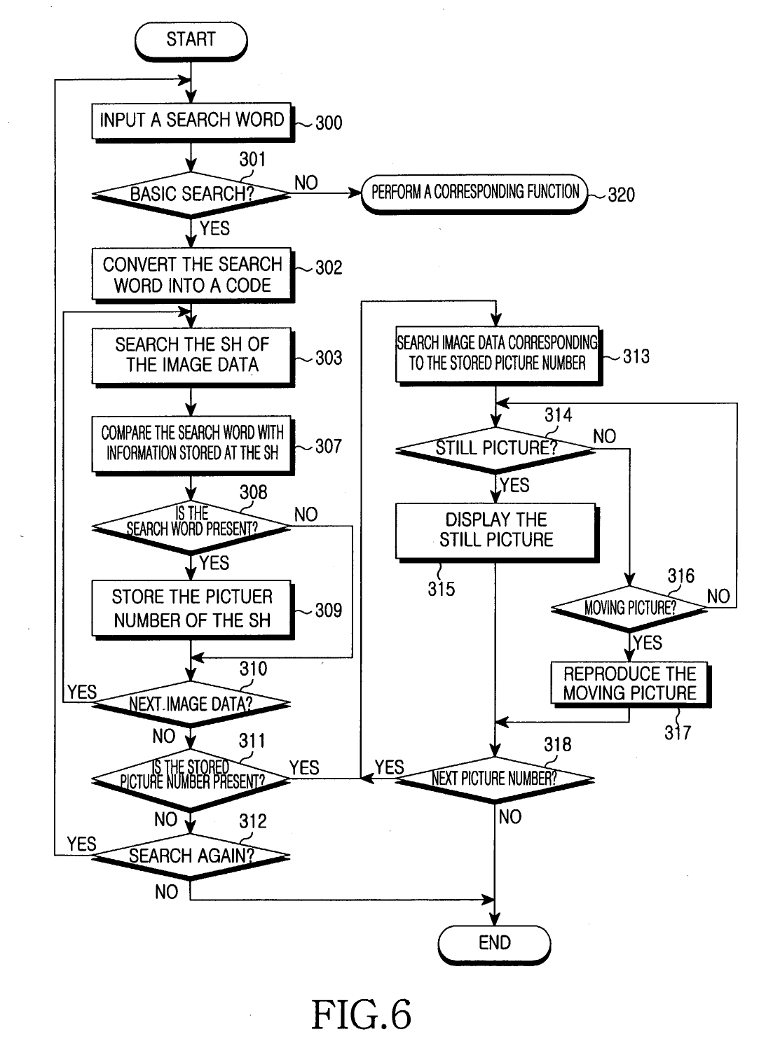

FIG. 6 is a flow chart showing an example of a process of searching for image data when a keyword is inputted under a basic search condition, according to the embodiment of the present invention.

Hereinafter, the embodiment of the present invention will be described in more detail, with reference to FIGS. 1 to 4.

If the user inputs a search word, the control section of the server will sense the input, and determine the search condition of the inputted word at step 300. If the search condition of the inputted word is a basic search for a single word, the control section of the server will sense this search condition at step 301 and will convert the inputted search word into code at step 302. The control section is then compressed, and proceeds with step 303 for searching for the sequence header (SH) of the image data stored in the memory of the server. At step 303, the control section of the server confirms a code informing the beginning of the header in the field 100 of the sequence header (SH) and a code informing the beginning of the information in the field 120, and detects the sequence header (SH). At step 307, the control section compares the search word converted into code with an information code stored in the field 130 of the sequence header (SH). If the code-converted search word exists in the information code stored in the field 130 of the sequence header (SH), the control section will sense the existence of the word at step 308, and proceed with step 309. At step 309, the control section stores in the memory of the server a code informing the picture number stored in the field 100 of the sequence header (SH) of the image data, in which the search word inputted at step 300 exists. While repeating steps 303 through 310, the control section searches all the compressed image data stored in the memory of the server. When the search for all the compressed image data is completed, the control section will sense the search completion at step 310 and will search the memory of the server in order to confirm whether the picture number stored at step 309 exists. If the picture number stored in the memory exists, the control section will sense the existence of it at step 311 and will proceed with step 313 for searching for image data corresponding to the stored picture number.

If the picture number stored in the memory of the server does not exists, the control section will sense the failure to find image data corresponding to the inputted search word at step-311 and will proceed with step 312 for performing an additional search or terminating the search process.

The control section determines whether the image data found at step 313 is a still picture or a moving picture. If the image data found at step 313 is a still picture, the control section will sense this at step 314, and proceed with step 315 for displaying the found still picture on the display section 30 (see FIG. 1). If the image section found at step 313 is a moving picture, the control section will sense this at step 316 and will proceed with step 317 for reproducing the found moving picture on the display section 30. By repeating steps 313 through 318, the control section enables the user to see the image data corresponding to the picture number stored at step 309 through the display section 30.

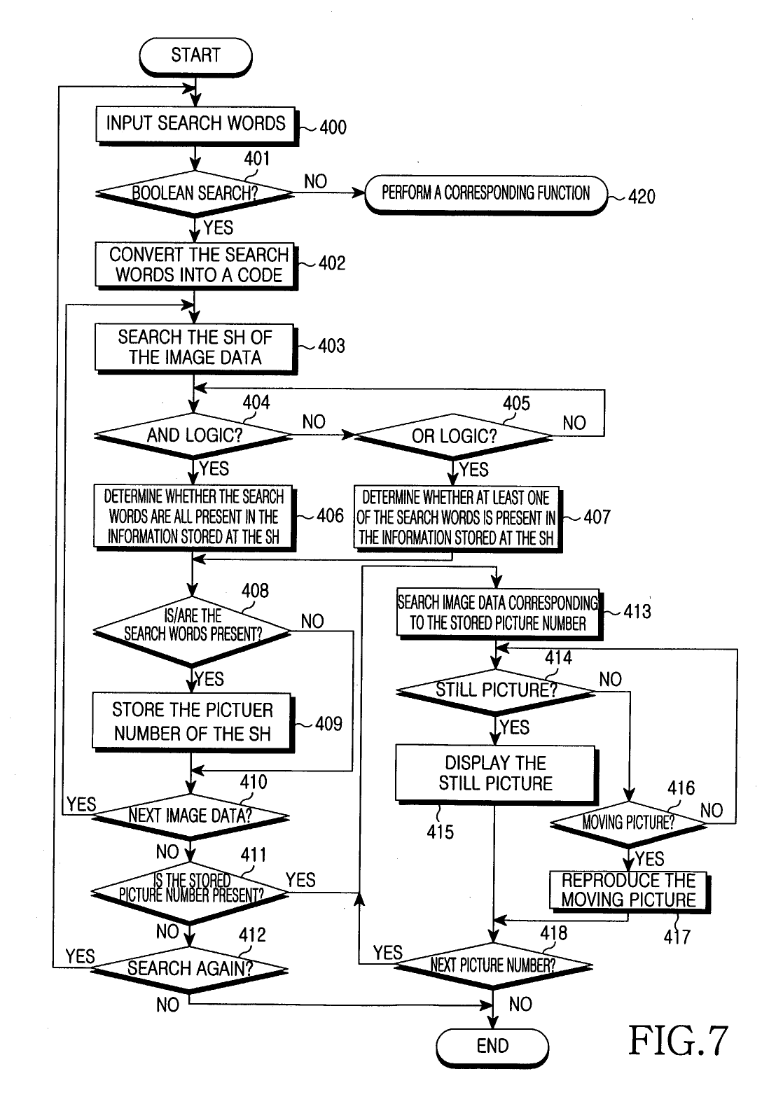

FIG. 7 is a flow chart showing an example of a process of searching for image data when a keyword is inputted under a boolean search condition, according to an embodiment of the present invention.

Hereinafter, the embodiments of the present invention discussed above will be described in more detail, with reference to FIGS. 1 to 4.

If the user inputs search words, the control section of the server will sense the input and determine the search condition of the inputted words at step 400. If the search condition of the inputted words is a boolean search (AND, OR) for two or more words, the control section of the server will sense this search condition at step 401 and will convert the input search words into code at step 402. The control section is then compressed and proceeds with step 403 for searching for the sequence header (SH) of the image data stored in the memory of the server. At step 403, the control section of the server confirms a code informing the beginning of the header in the field 100 of the sequence header (SH) and a code informing the beginning of the information in the field 120 and then detects the sequence header (SH).

If the search words were input under “AND” logic at step 400, the control section will sense this search condition at step 404 and will proceed with step 406. At step 406, the control section compares the search words converted into code at step 402 with an information code stored in the field 130 of the sequence header (SH) and determines whether all the search words are present in the information code.

If the search words were input under “OR” logic at step 400, the control section will sense this search condition at step 405 and will proceed with step 407. At step 407, the control section compares the search words converted into a code at step 402 with an information code stored in the field 130 of the sequence header (SH) and determines whether at least one of the search words is present in the information code.

If the search words inputted under “AND” logic at step 400 are all present in the information code stored in the field 130 of the sequence header (SH) at step 406, or if at least one of the search words inputted under “OR” logic at step 400 is present in the information code stored in the field 130 of the sequence header (SH) at step 407, the control section will sense the presence of any search words at step 408 and will proceed with step 409. At step 409, the control section stores in the memory of the server a code informing the picture number stored in the field 100 of the sequence header (SH) of the image data, in which the search words inputted at step 400 exist. While repeating steps 403 through 410, the control section searches all the compressed image data stored in the memory of the server. When the search for all the compressed image data is completed, the control section will sense the search completion at step 410 and will search the memory of the server in order to confirm whether the picture number stored at step 409 exists. If the picture number stored in the memory exists, the control section will sense the existence of it at step 411 and will proceed with step 413 for searching for image data corresponding to the stored picture number.

If the picture number stored in the memory of the server does not exist, the control section will sense the failure to find image data corresponding to the inputted search words at step 411 and will proceed with step 412 for performing an additional search or terminating the search process.

The control section determines whether the image data found at step 413 is a still picture or a moving picture. If the image data found at step 413 is a still picture, the control section will sense it at step 414 and will proceed with step 415 for displaying the searched still picture on the display section 30 (see FIG. 1). If the image section found at step 413 is a moving picture, the control section will sense it at step 416 and will proceed with step 417 for reproducing the found moving picture on the display section 30. By repeating steps 413 through 418, the control section enables the user to see the image data corresponding to the picture number stored at step 409 through the display section 30.

As can be appreciated by one skilled in the art, the embodiments of the present invention having the construction and operation as explained above produce advantageous effects. That is, the present invention for searching for image data using keywords enables the user of a mobile phone to easily and rapidly search for required image data.

While the invention has been shown and described with reference to certain embodiments thereof, it will be understood by those skilled in the art that various changes in form and details may be made therein without departing from the spirit and scope of the invention as defined by the appended claims.

What is claimed is:

1. A method for compressing image data having been made searchable by a keyword, the method comprising the steps of:
compressing image data; and
converting information represented by said image data into code, and storing the code at a sequence header (SH) of said compressed image data.

2. The method according to claim 1, wherein said sequence header (SH) comprises a field adapted to store a code identifying a picture number; a field adapted to store a code identifying the beginning of the header; a field adapted to store a code identifying the beginning of information; a field adapted to store information of said image data converted into code; a field adapted to store a code identifying the end of the information; and a field adapted to store a code identifying the end of the header.

3. The method according to claim 1, wherein the information of said image data stored in the sequence header (SH) is divided by a particular size in order to be stored.

4. The method according to claim 1, wherein said compressed image data is one of a still picture and a moving picture.

5. The method according to claim 1, wherein said image data is compressed by JPEG or MPEG.

6. A method of searching for image data using a keyword, the method comprising the steps of:
inputting a search word;
determining whether the search condition of said input search word is a basic search;
converting the input search word into a code;
searching for a sequence header (SH) of compressed image data;
comparing said search word, which has been converted into code, with an information code stored at said sequence header (SH) to determine whether said input search word is present;
storing a picture number of said sequence header (SH), if said search word is present;
searching for image data corresponding to the stored picture number;
determining whether the searched image data is a still picture or a moving picture; and
if said image data is a still picture, displaying the still picture, or if said image data is a moving picture, reproducing the moving picture.

7. The method according to claim 6, wherein said step of searching for a sequence header (SH) of compressed image data comprises the steps of:
determining whether there is a code informing the beginning of the header; and
determining whether there is a code informing the beginning of the information.

8. The method according to claim 6, further comprising the step of completing the search if a code informing the end of the header or a code informing the end of the information is detected.

9. The method according to claim 6, wherein said basic search is performed for a single word.

10. A method of searching for image data using a keyword, the method comprising the steps of:
inputting search words; determining whether the search condition of said inputted search words is a boolean search;
converting the inputted search words into code;
searching for a sequence header (SH) of compressed image data;
determining whether the search words, which has been converted into code, are all present in an information code stored at the sequence header (SH) if the search condition of the inputted search words is “AND” logic, or whether at least one of the search words, which has been converted into code, is present in an information code stored at the sequence header (SH) if the search condition of the inputted search words is “OR” logic;
storing a picture number of said sequence header (SH) if said search word(s) is present;
searching for image data corresponding to the stored picture number;
determining whether found image data is a still picture or a moving picture; and
if said image data is a still picture, displaying said still picture, or if said image data is a moving picture, reproducing said moving picture.

11. The method according to claim 10, wherein said step of searching for a sequence header (SH) of compressed image data comprises the steps of:
determining whether there is a code informing the beginning of the header; and
determining whether there is a code informing the beginning of the information.

12. The method according to claim 10, further comprising the step of completing the search if a code informing the end of the header or a code informing the end of the information is detected.

13. The method according to claim 10, wherein said boolean search is performed for two or more words under “AND” or “OR” logic.

14. A system for compressing image data having been made searchable by a keyword, the system comprising:
a data compressor, adapted to compress image data; and
a data converter, adapted to convert information represented by said image data into code, and store the code at a sequence header (SH) of said compressed image data.

15. The system according to claim 14, wherein said sequence header (SH) comprises a field adapted to store a code identifying a picture number; a field adapted to store a code identifying the beginning of the header; a field adapted to store a code identifying the beginning of information; a field adapted to store information of said image data converted into code; a field adapted to store a code identifying the end of the information; and a field adapted to store a code identifying the end of the header.

16. The system according to claim 14, wherein the information of said image data stored in the sequence header (SH) is divided by a particular size in order to be stored.

17. The system according to claim 14, wherein said compressed image data is one of a still picture and a moving picture.

18. The system according to claim 14, wherein said image data is compressed by JPEG or MPEG.

19. A system for searching for image data using a keyword, the system comprising:
an input, adapted to input a search word; and
a controller, adapted to perform the following operations:
determine whether the search condition of said input search word is a basic search;
convert the input search word into a code;
search for a sequence header (SH) of compressed image data;
compare said search word, which has been converted into code, with an information code stored at said sequence header (SH) to determine whether said input search word is present;
store a picture number of said sequence header (SH), if said search word is present;
search for image data corresponding to the stored picture number;
determine whether the searched image data is a still picture or a moving picture; and
if said image data is a still picture, display the still picture, or if said image data is a moving picture, reproduce the moving picture.

20. The system according to claim 19, wherein said controller searches for a sequence header (SH) of compressed image data by performing operations including the following:
determining whether there is a code informing the beginning of the header; and
determining whether there is a code informing the beginning of the information.

21. The system according to claim 19, wherein said controller completes the search if a code informing the end of the header or a code informing the end of the information is detected.

22. The system according to claim 19, wherein said controller performs said basic search for a single word.

23. A system for searching for image data using a keyword, the system comprising:
an input, adapted to input search words; and
a controller, adapted to perform the following operations:
determine whether the search condition of said inputted search words is a boolean search;
convert the inputted search words into code;
search for a sequence header (SH) of compressed image data;
determine whether the search words, which has been converted into code, are all present in an information code stored at the sequence header (SH) if the search condition of the inputted search words is “AND” logic, or whether at least one of the search words, which has been converted into code, is present in an information code stored at the sequence header (SH) if the search condition of the inputted search words is “OR” logic;
store a picture number of said sequence header (SH) if said search word(s) is present;
search for image data corresponding to the stored picture number;
determine whether found image data is a still picture or a moving picture; and
if said image data is a still picture, display said still picture, or if said image data is a moving picture, reproduce said moving picture.

24. The system according to claim 23, wherein said controller searches for a sequence header (SH) of compressed image data by performing operations comprising the following:
determining whether there is a code informing the beginning of the header; and
determining whether there is a code informing the beginning of the information.

25. The system according to claim 23, wherein said controller completes the search if a code informing the end of the header or a code informing the end of the information is detected.

26. The system according to claim 23, wherein said boolean search is performed for two or more words under “AND” or “OR” logic.
